(19) United States
(12) Patent Application Publication
(10) Pub. No.: US 2002/0118904 A1
(43) Pub. Date: Aug. 29, 2002

(54) Optical fiber systems for transmitting laser light with reduced back reflection interference

(75) Inventors: Hong-Tai Man, Bernards Township, NJ (US); Steven L. Moyer, Sinking Spring, PA (US); Mary J. Nadeau, Bethlehem, PA (US); Paul Nicholas Pappas, Bernville, PA (US); Renyi Yang, Santa Barbara, CA (US); Rao V. Yelamarty, Allentown, PA (US); Craig A. Young, Nazareth, PA (US)

Correspondence Address: Glen E. Books, Esq., Lowenstein Sandler, 65 Livingston Avenue, Roseland, NJ, 07068, US

(73) Assignee: AGERE SYSTEMS

(21) Appl. No.: 09/794,936

(22) Filed: Feb. 27, 2001

(51) Int. Cl. G02B 6/27; G02B 6/32

(52) U.S. Cl. 385/11; 385/35

(57) ABSTRACT

In accordance with the invention, an optical fiber system comprising a laser source an optical fiber including a reflective input end for receiving light from the source is provided with a polarization quarter-wave plate between the laser and the reflective end for minimizing power fluctuations from back reflection. The quarter-wave plate does not prevent back reflection but rather rotates the polarization of the back reflected light so that it does not interfere with the polarized light within the cavity. In an advantageous embodiment the quarter-wave plate is disposed within a receptacle laser package.

### FIELD OF THE INVENTION

This invention relates to optical fiber systems that transmit laser light over optical fiber and, in particular, to such systems adapted to transmit laser light with reduced back reflection interference.

### BACKGROUND OF THE INVENTION

One of the major advances in communications in recent years has been the use of optical fiber systems for carrying large quantities of information with low distortion and low cost over great distance. Such systems typically comprise sources of signal light, lengths of optical fiber waveguide to carry the signal light, optical fiber amplifiers including sources of pump light, optical switches for directing the signal light within a fiber network and optical receivers for the signal light. The optical sources are typically lasers such as compact semiconductor lasers. The optical fibers are thin strands of glass that transmit light by total internal reflection, and the optical switches are increasingly free-space photonics switches that take light beams from the end of a bundle of input fibers, perform the desired switching function (as with a MEMs mirror array) and project the switched beams into the ends of a bundle of output fibers.

Back reflection of laser light is an important problem in optical fiber systems. There are numerous reflecting surfaces between a laser source and the end of a fiber network. The first such reflecting surface is typically encountered where the laser is coupled to the optical fiber. In a typical laser packaging arrangement, referred to as a receptacle laser package, the laser output is focused onto the plane where the user inserts the end of an optical fiber. This fiber end receives the laser output, but typically reflects a portion of the laser output back into the laser causing interference inside the laser cavity and producing fluctuations in laser output power. Other reflecting surfaces may be encountered further downstream at junctures with fiber amplifiers or at optical switches. Each such surface presents additional back reflection and causes additional undesirable power fluctuations.

Conventional approaches to eliminating back reflection are expensive, time consuming or both. One approach is to dispose an optical isolator between the laser and the reflecting surface. The isolator, which blocks all returning light, is effective but quite expensive, especially if provided to each of many different sources. Another approach is to cut each fiber end surface as an angled fiber stub, the end surface cut at a precise angle that accepts much of an input beam along the system axis and reflects the portion it does not accept off the optical axis. This approach is expensive and time consuming, especially for an array of fibers. Accordingly there is a need for a low-cost solution to back reflection in laser-driven optical fiber systems.

### SUMMARY OF THE INVENTION

In accordance with the invention, an optical fiber system comprising a laser source an optical fiber including a reflective input end for receiving light from the source is provided with a polarization quarter-wave plate between the laser and the reflective end for minimizing power fluctuations from back reflection. The quarter-wave plate does not prevent back reflection but rather rotates the polarization of the back reflected light so that it does not interfere with the polarized light within the cavity. In an advantageous embodiment the quarter-wave plate is disposed within a receptacle laser package.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 is a schematic top view of a receptacle laser package in accordance with the invention;

FIGS. 2A and 2B are schematic polarization diagrams showing exemplary polarizations of an outgoing beam from the laser of FIG. 1; and

FIGS. 3A and 3B show polarizations of the FIG. 2 beam reflected back toward the laser.

It is to be understood that these drawings are for purposes of illustrating the concepts of the invention and are not to scale.

### DETAILED DESCRIPTION

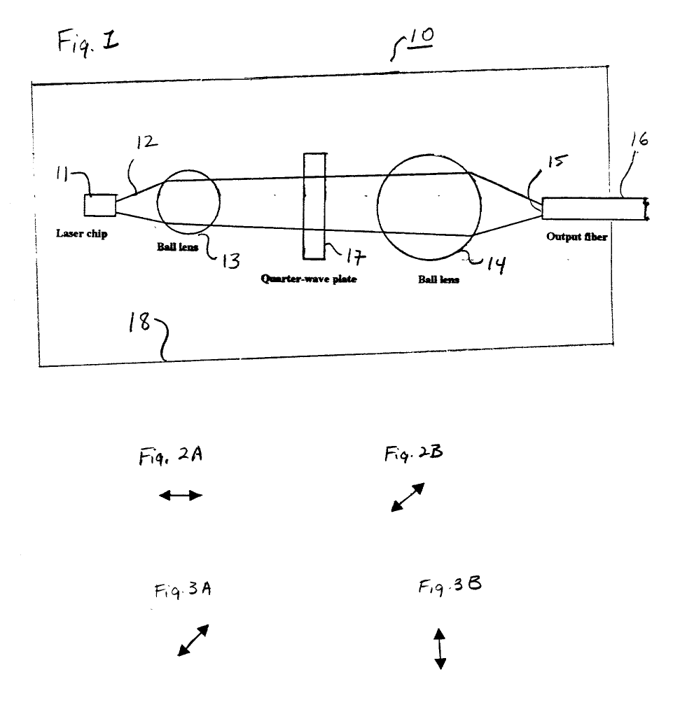

Referring to the drawings, FIG. 1 is a schematic top view of a receptacle laser package 10 comprising a laser 11 for emitting a linearly polarized output beam 12, a collimating lens 13 for approximately collimating lens 13 for approximately collimating beam 12 and a focusing lens 14 for focusing the beam 12 on the end 15 of an output fiber 16. In accordance with the invention, a polarization quarter-wave plate 17 is disposed in the path of beam 12 between the laser 11 and the fiber end 15. Conveniently the quarter-wave plate 17 is disposed between lenses 13 and 14. The components 11, 13, 14, 16 and 17 can all be conveniently mounted on a common substrate 18 and within a housing (not shown).

In operation, the laser 11 emits a linearly polarized light beam 12. This linear polarization can, for example, be is schematically illustrated as horizontal in FIG. 2A. After collimation, the horizontally polarized beam passes through quarter-wave plate 17. The quarter-wave plate rotates the linear polarization by 45° as shown in FIG. 2B. The beam 12 is then focused by lens 14 on the end 15 of fiber 16. Most of the beam enters the fiber within the critical acceptance angle of the fiber and is transmitted therein by total internal reflection.

A portion of the beam 12 is reflected back from end 15 to retrace the beam path. The reflected beam initially has a linear polarization at a 45° degree angle from horizontal as shown in FIG. 3A. After passing through quarter-wave plate 17, the reflected beam undergoes an additional 450 rotation of its linear polarization so that when it arrives back at laser 11, the beam is now orthogonally polarization in relation to light in the laser as shown in FIG. 3B. Because polarization of the back reflected light is orthogonal to light in the laser, the back reflected light will not interfere with light in the cavity and will not produce power fluctuations in the laser. It is noteworthy that this arrangement protects the laser source 11 without a separate polarizer. It should also be noted that the same protection would be obtained irrespective of the polarization orientation of the linearly polarized output beam 12, i.e. it need not be horizontally polarized.

The invention may now be more clearly understood by consideration of the following specific example. The laser is a Fabry Perot junction diode laser emitting light at wavelength of 1.31 micrometers. The collimating lens 13 is a ball lens of BK-7 glass having a diameter of 0.8 mm. The lens 14 is a ball lens of diameter 2 mm. The quarter-wave plate 17 is a slab of quartz having a thickness of 0.49 mm with an optic axis 45° to the polarization of the laser light, and the fiber 16 is a conventional glass transmission fiber having a polished flat end 15.

It is to be understood that the above-described embodiments are illustrative of only a few of the many possible specific embodiments which can represent application of the principles of the invention. Numerous and varied other arrangements can be readily devised by those skilled in the art without departing from the spirit and scope of the invention.

What is claimed:

1. An optical fiber system for transmitting laser light with reduced back reflection interference comprising:
a laser for emitting linearly polarized light;
an optical fiber having a partially reflective end surface for receiving light from the laser; and
dispersed between the laser and the fiber end surface, a polarization quarter-wave plate, the quarter-wave plate rotating the polarization of light reflected back toward the laser from the fiber end surface to a linear polarization that is orthogonal to the linear polarization of light emitted from the laser.

2. The system of claim 1 further comprising a first lens for collimating the light emitted by the laser and a second lens for focusing the collimated light on the optical fiber end.

3. The system of claim 1 wherein the quarter-wave plate is disposed between the first and second lenses.

4. The optical fiber system of claim 1 wherein the laser, the quarter-wave plate and the fiber are mounted on a common substrate.

5. The optical fiber system of claim 2 wherein the laser, the quarter-wave plate, the fiber and the lenses are mounted on a common substrate.
